(19) United States
(12) Patent Application Publication
(10) Pub. No.: US 2003/0126157 A1
(43) Pub. Date: Jul. 3, 2003

(54) Method for automatically organizing template files in a web-based file retrieval sytstem

(76) Inventors: Calvin Kayan Young, Schenectady, NY (US); Venkatesan Palani, Niskayuna, NY (US)

Correspondence Address: NIXON & VANDERHYE P.C., 8th Floor, 1100 North Glebe Road, Arlington, VA, 22201, US

(21) Appl. No.: 10/028,934

(22) Filed: Dec. 28, 2001

(51) Int. Cl. G06F 17/30

(52) U.S. Cl. 707/200

(57) ABSTRACT

For use in designing a gas turbine engine, a database having a plurality of sections, each section storing one or more templates, a method of reorganizing a select template from one section to a different section within the plurality of sections includes reviewing an index file corresponding to the select template to identify a section among the plurality of sections where the select template is organized. The method further includes editing a storage location of the index file to identify a different section among the plurality of sections to reorganize the select template to the different section without moving underlying files of the select template between the plurality of sections to design the gas turbine engine.

### FIELD OF THE INVENTION

This invention relates to databases, and more particularly, to a method for automatically organizing template files in a web-based file retrieval system for use in turbine design.

### BACKGROUND OF THE INVENTION

Turbine design and manufacture requires designers to consult various sources for design data and specification document information. A schematic of a typical gas turbine engine 100 as illustrated in FIG. 1 includes a compressor 102, a combustor 104, and a turbine 106.

A design engineer may consult one or more databases during the design and manufacturing steps of a gas turbine engine, for example, such as the one illustrated in FIG. 1. The design engineer may use one or more templates to identify a specific template attribute and its corresponding relation to a turbine component or a component part. In general, a template indicates the correspondence between a field/attribute and specific parts of a turbine. A database that a design engineer consults during turbine design typically includes fields having information for related to turbine design—each field within the database referring to a specific part of a turbine. Several templates may be created and stored in the database to educate users regarding database fields and their respective relationship to various components or component parts of a turbine.

Typically, master copies of templates are created on paper and placed in a binder/folder. Each user is provided with a copy of the binder with the templates organized by turbine parts within the binder. As turbine parts and users increase, management of paper copies becomes increasingly burdensome. Further, since paper copies generally remain uncontrolled, the probability of users marking the copies and thus compromising the accuracy and integrity of the documents is high. Furthermore, since each user is provided with a copy of the binder, a large amount of paper is required to satisfy user demand. Other problems involving paper copies include difficulty in tracking all the users in order to forward revisions made to various templates present in the binder, thus creating further wastage of paper. In addition, there is always an added burden and difficulty to ensure whether or not all the users have updated their respective binders.

Some of the above identified problems are in conflict with International Standards Organization (ISO) procedures, while others are in conflict with business initiative for electronic documents. Thus, there is a need for a system to overcome the above-identified problems while resolving the conflicts.

### SUMMARY OF THE INVENTION

Accordingly, the present invention relates to a method and apparatus for automatically organizing templates in a web-based file retrieval system used for turbine design. More particularly, it relates to a web-based file management system having digitized template information stored therein in a plurality of sections to provide on-line access to various users. The method involves reorganizing the templates without actually moving files making up the templates.

The web-based file management and retrieval system of the present invention provides easy access to various templates that are stored therein. A plurality of templates are organized and stored in a database, in one or more sections, within the file management system in a single directory, each template relating to a part of a turbine. The file management and retrieval system also enables a user to search for particular database fields of a template. An automated notice function notifies registered users of any changes made to the templates while allowing administrators to reorganize one or more templates into various sections. This step of reorganizing the templates is performed without physically moving files making the templates between various sections. Index files associated with templates enables a user to organize and arrange the templates into various sections within the file management system. Each index file also stores such information as, for example, various fields found in a template, storage location of a file related to a specific part of a turbine, revision and update information of a template, etc.

In operation, a remote user may login to a web server using an established username and a password. Once the user logs in to the web server, a plurality of tabs/sections are displayed to the user, the tabs/sections being created from index files with each index file representing a specific template. When the user selects a tab/section via a user interface, such as a mouse, a plurality of templates located within the selected tab/section are displayed to the user. Upon selecting a specific template among the plurality of displayed templates, a PDF file for the selected template is enabled for download from a location identified in an index file that is specific to the selected template. The PDF file for the selected template may be downloaded locally by the remote user and automatically displayed on the user's display device. The remote user may perform various processing tasks locally. Such tasks may include, storing the downloaded file in local storage device, printing the downloaded file, including the downloaded file in the user's profile, etc.

If the remote user is unfamiliar with a template related to a specific gas turbine part, then the user may initiate a search to locate a relevant templates from among the plurality of templates organized in various sections within a directory.

The remote user may also be authorized (i.e., as an administrator) to reorganize the templates located in a specific tab/section. As each template includes a specific index file identifying a storage location for the template, an authorized remote user or an administrator may reorganize a specific template into a different tab/section. The reorganization step is effected by modifying the storage location in an index file to a new location. In this fashion, a specific template is automatically moved from one section to another without physically moving the files making up the template.

In one aspect, this invention provides for use in designing a gas turbine engine, a database having a plurality of sections, each section storing one or more templates, a method of reorganizing a select template from one section to a different section within the plurality of sections. The method includes reviewing an index file corresponding to the select template to identify a section among the plurality of sections where the select template is organized. A storage location of the index file is edited to identify a different section among the plurality of sections to reorganize the select template to the different section without moving underlying files of the select template between the plurality of sections to design the gas turbine engine.

The templates preferably are in PDF format. A storage location of the select template is preferably included in a header portion of a corresponding index file and each index file is populated with corresponding template details. A user is enabled to search contents of one or more templates. The method also preferably includes tracking templates having altered index files; and notifying users of template reorganization. Each index file includes one or more of (i) fields identified within a template, (ii) storage locations of components described by a template, (iii) revision and update information of a template. Further, at least one of a revision number, revision date, or description of revisions performed is included in the revision information. User profiles are preferably stored as text files in a server.

Another aspect of this invention involves a computer program product having a computer useable medium having computer program logic stored thereon for enabling a processor in a computer system to process data, the computer program product including a database having a plurality of templates stored therein for use in turbine design; means for checking an index file corresponding to a select template to identify a section among a plurality of sections where the select template is organized. The computer program product also includes means for editing a storage location of the index file to reorganize the select template to a different section among the plurality of sections without moving underlying files of the select template between the plurality of sections.

In another aspect, the present invention involves a computer-based method for reorganizing a template among a plurality of templates stored in a plurality of sections within a database for use in turbine design, the method comprising storing the plurality of templates in a first organized model in the database, each template having an associated index file. The plurality of templates and an index file corresponding to a selected template are displayed by user action. The index file is edited to reorganize the selected template from the first organized model to a second organized model.

In another aspect, the present invention provides in a electronic communication network having a client computer system communicatively coupled to a server computer for accessing information stored therein for use in designing a gas turbine engine, the server computer comprising a memory for storing a plurality of templates in a first organized model in the memory, each template having an associated index file. A software application stored in the memory enables retrieval and display of template information on a display device of the client computer system in response to user action. The software application further enables a user to edit an index file corresponding to a displayed template to reorganize the displayed template from the first organized model to a second organized model.

Another aspect of this invention involves a method of reorganizing a plurality of templates for designing a gas turbine engine, the templates being organized in a plurality of sections within a database, the method comprising displaying the plurality of templates, each template having an associated index file indicating a section where a respective template is stored. A user is enabled to select a template from the plurality of templates and display contents of the select template. The user is further enabled to modify the index file associated with the select template for reorganizing the select template to a different section among the plurality of sections. The reorganization step is executed without moving files making up the select template.

Another aspect of the present invention involves a method for reorganizing one or more templates arranged in a plurality of sections in a database of a remote server, the server using a software application, the method comprising communicatively coupling the server to a plurality of remote client computers and accessing the server from one or more client computers. The software application is analyzed to identify one or more of functions, processes, procedures, and steps for reorganizing the one or more templates. An index file corresponding to respective one or more templates is identified and edited to reorganize a template corresponding to the select index file. The reorganized templates are displayed to a user for use in designing a turbine.

Still another aspect of this invention involves a method for reorganizing files stored in a file management system, the files arranged in a plurality of sections within the file management system, the method comprising accessing a server from one or more remote client computers, the server storing the file management system. The plurality of sections are retrieved and displayed on a remote client computer. The method further includes selecting a section from the plurality of sections and displaying templates included in the selected section. A template is selected from the displayed templates and an image corresponding to the selected template is displayed. An index file corresponding to the selected template is edited for reorganizing the selected template into another section among the plurality of sections without moving underlying template files between the plurality of sections.

In a further aspect, the present invention involves a system having a storage device, comprising information having segments, the storage device having a set of templates. Each template indicates the content of a corresponding one of said segments. The templates are preferably arranged in an organized first model reflecting relationships among corresponding segments. The storage device further includes software for reorganizing the templates into a second model and displaying the reorganized templates. The software preferably enables a user to access contents of the second model by invoking a corresponding template in the second model.

### BRIEF DESCRIPTION OF THE DRAWINGS

FIG. 1 is a schematic view of a typical gas turbine engine;

FIG. 2 illustrates a schematic view of an exemplary system for enabling remote user to communicate and retrieve template information from a web-server used for designing a gas turbine engine;

FIG. 3 illustrates an exemplary system diagram of the web-based server shown in FIG. 2;

FIG. 4 is a user interface screen shot for enabling a user to access a template in accordance with an exemplary embodiment of the present invention;

FIG. 5 is a user interface screen shot showing various tabs/sections and files located in a tab/section in accordance with an exemplary embodiment of the present invention;

FIG. 6 is a user interface screen shot illustrating index information of a select file and a PDF file corresponding to the index file in accordance with an exemplary embodiment of the present invention;

FIGS. 7-10 show various user interface screen shots illustrating steps involved in the reorganization of a template from one tab/section into another tab/section in accordance with an exemplary embodiment of the present invention;

FIGS. 11-12 show a flowchart illustrating the process steps involved in reorganizing templates from one tab/section to another in accordance with an exemplary embodiment of the present invention;

FIG. 13 illustrates an exemplary computer system used by a user or an administrator as shown in FIG. 2 for designing a gas turbine engine; and

FIG. 14 shows an exemplary file structure of an index file before and after reorganization of a template from one tab/section to another as illustrated in FIGS. 7-10.

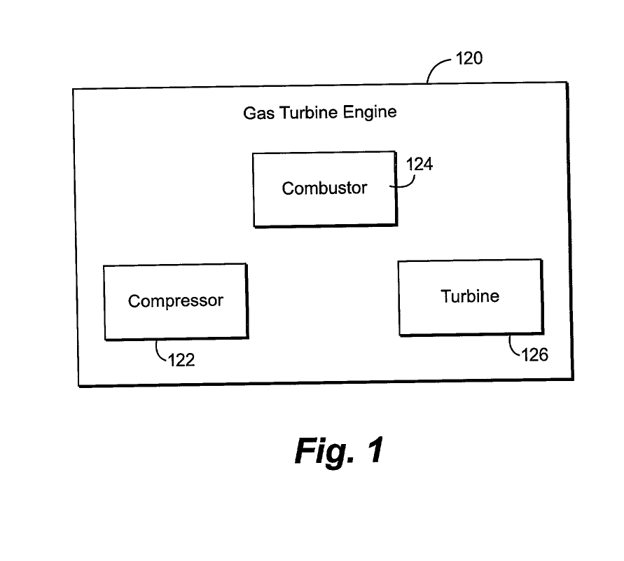

### DETAILED DESCRIPTION OF EXEMPLARY EMBODIMENTS

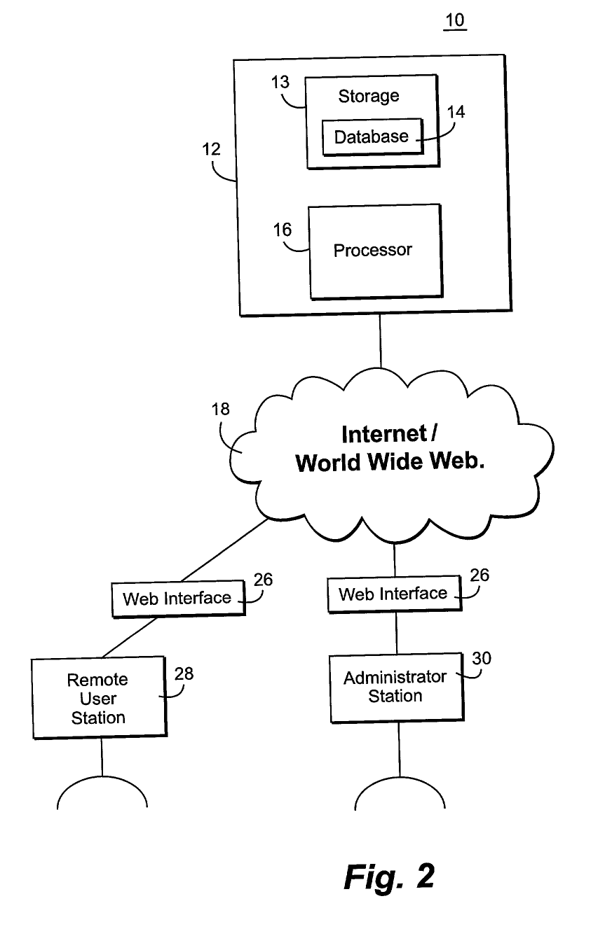

FIG. 2 illustrates an exemplary system 10 for allowing a user at user station 28 easy access to template files stored in a storage device 13 of a web server 12. The template files stored in the storage device 13 may also be organized in a database 14 which may be a part of the storage device 13. The web server 12, for example, may be a UNIX based system with processing and communication software. The storage device 13 further stores other support tools, such as backend utilities and programs for enabling the remote user system 28 to download and display a specific template or reorganization of templates within the various tabs/sections within the storage device 13 by a user at an administrator station 30. A processor 16 processes various tasks and controls the operation of the web-server 12.

The user station 28 and administrator station 30, respectively, are communicatively coupled to an Internet or world-wide-web 18 via a web-interface 26. Although FIG. 2 shows a single user and a single administrator for simplicity, it will be understood that a plurality of remote users use template files stored in database 14, and likewise, more than one administrator may administer system 10. The remote user 26 may be notified, via various modes of communication, preferably via e-mail, or a pager, regarding any changes made to the template files by the administrator at station 30.

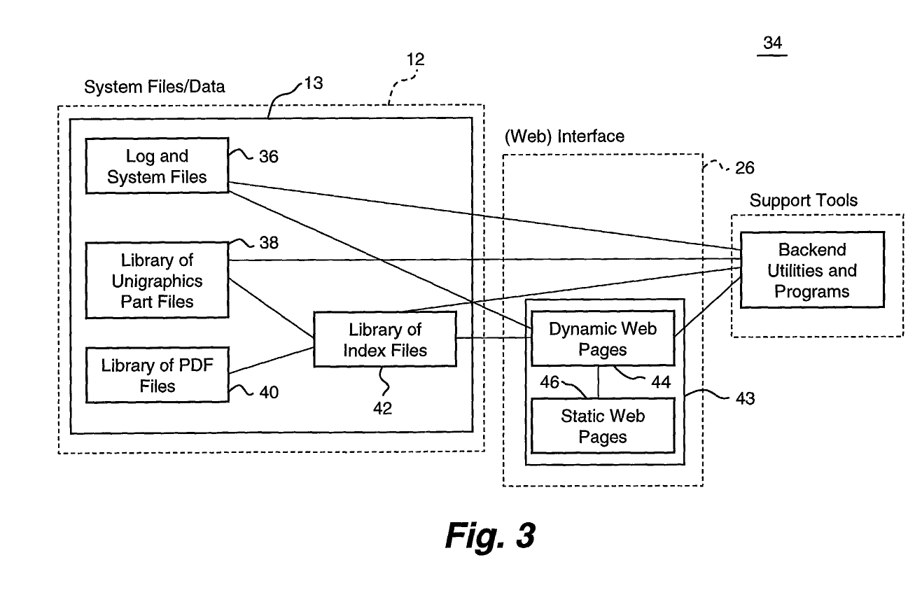

As shown in FIG. 3, the storage device 13 of the web server 12 stores log and system files 36, a library of unigraphics part files 38, a library of PDF files 40, and a library of index files 42. As noted before the database 14 may further store backend utilities and programs. Alternatively, the backend utilities and programs may be stored in a separate memory. Each remote user 28 accesses various files stored in the storage device 13 via a web interface 26. The web interface 26 has a storage device 43 for storing dynamic web pages 44 and static web pages 46.

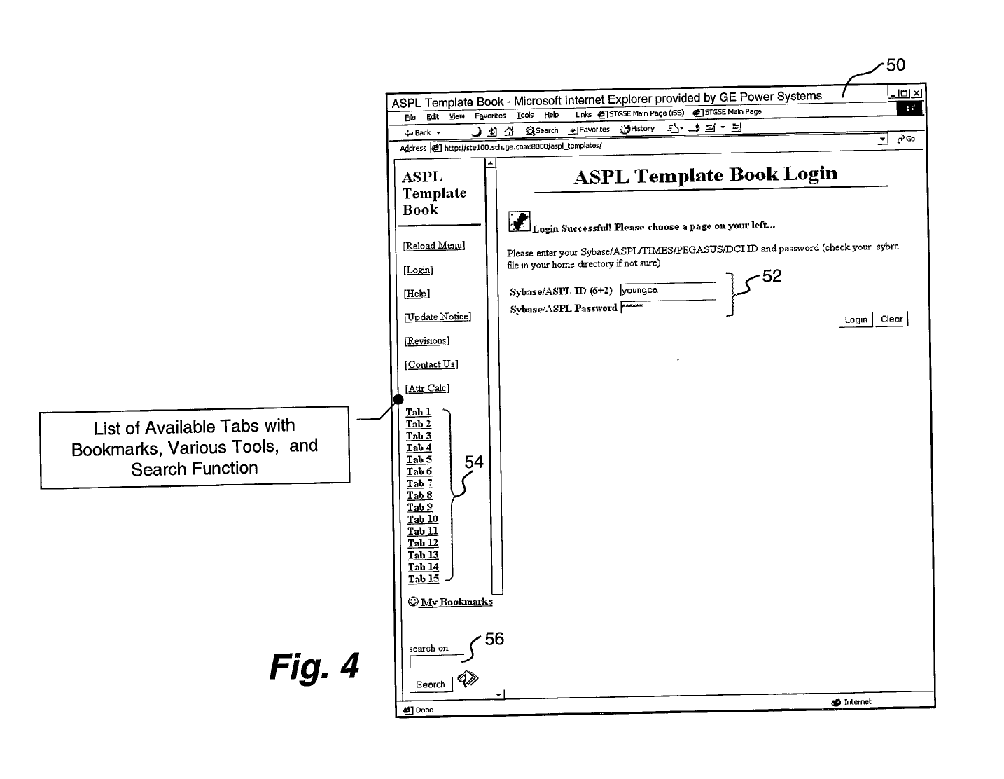

FIG. 4 shows an exemplary user interface screen displayed when the user accesses the server computer 12 (FIG. 2), having a unique IP address, via a web-browser. Generally known web browsers, such as for example, Netscape®, or Internet Explorer® from Microsoft Corporation may be used. The screen of FIG. 4 enables a user to log into the web-server 12 (FIG. 2) for accessing an online template book/template file stored in the storage device 13. Each user is assigned a unique username and a password for gaining access to the template files. A list of tabs/sections 54 is displayed to the user after the user successfully logs into the web-server 12. The user interface 50 also displays a search field 56 for enabling the user to search the contents of template files included in each of the tabs/sections.

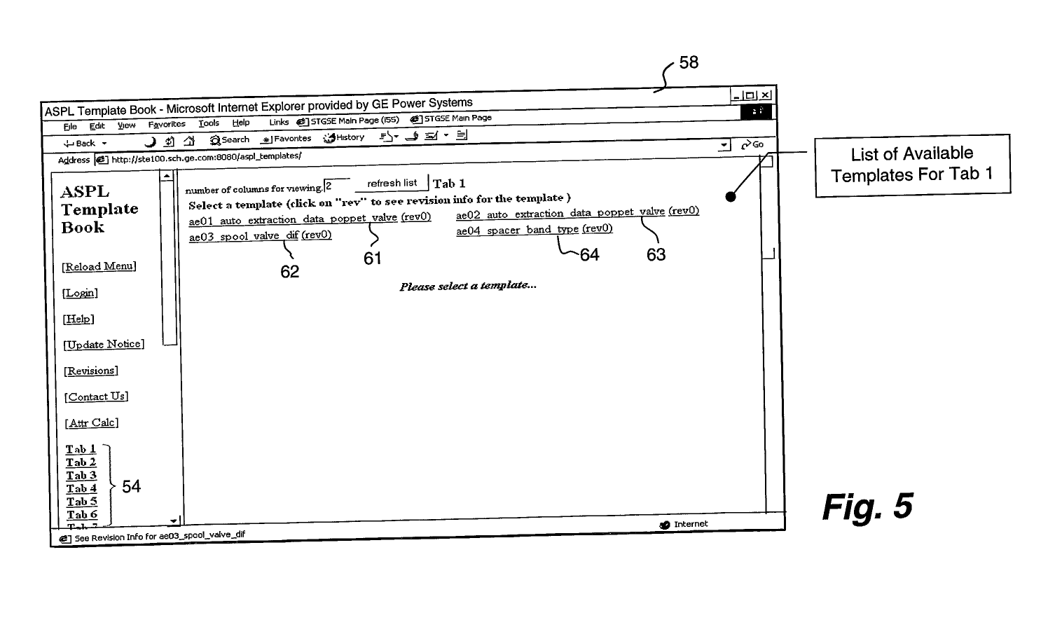

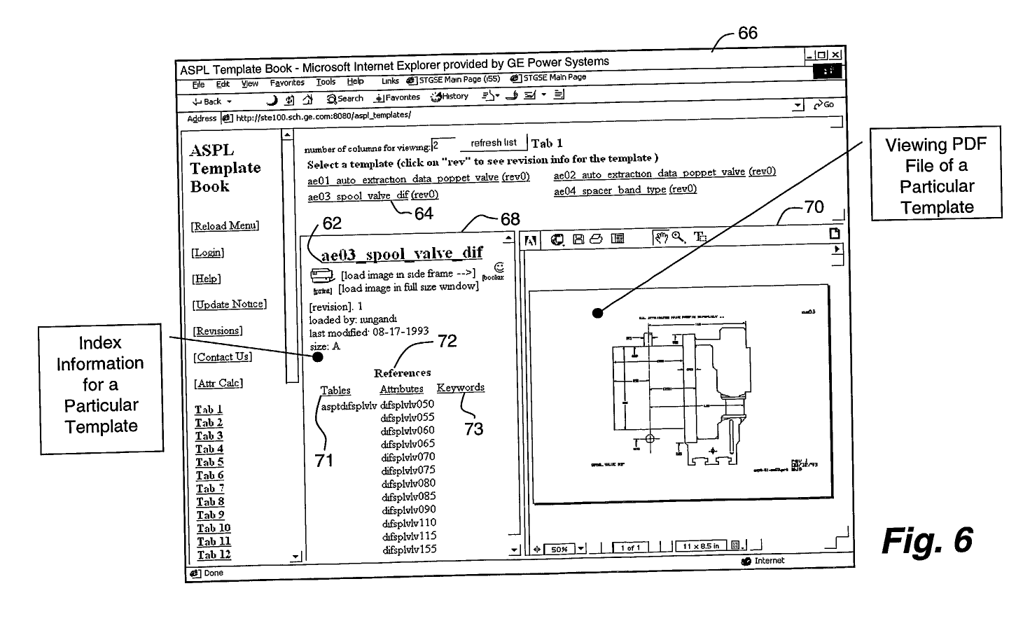

Each Tab identified at 54 (FIG. 4) may include a plurality of templates. For example, FIG. 5 shows templates in the form of index files 61-64 available for Tab 1. Upon selecting Tab 1 from the list of displayed Tabs 54 (FIG. 4), index files 61-64 included in Tab 1 are displayed to the user. Upon further selecting one of the index files, the user may be able to display the template identified by the selected file. For example, as shown in FIG. 6, if a file 62 (shown to be related to a spool valve of a gas turbine) is selected, the index information for an associated template is obtained from library 42 and displayed in menu 68.

A PDF file for the associated template is obtained from library 40 and downloaded by the user at user station 28 (FIG. 2) from a storage location indicated in the index file. The downloaded file is automatically opened and displayed in menu 70. The index information displayed in menu 68 may include such exemplary fields as Tables 71, Attributes 72, and Keywords 73 describing the template and the displayed PDF file in menu 70.

The index files generally are text files that may be stored in a single directory within the storage device 13 (FIG. 2) and particularly organized in library 42. The index files include information about the templates that they represent. Such information may include, for example, storage locations where PDF files corresponding to a template, the tab/section into which a template is currently organized, etc. Typically, one index file corresponds to one template. The database system 14 (FIG. 2) organizes such information as the identity of an administrator or a user having authority to update the template files, identity of a person(s) last updating the templates, the location where PDF files and part files of a gas turbine machine are stored, the location (i.e., Tab 1, Tab 2, . . . Tab N) to which each template is designated, the original paper size of a part file, attributes and tables found on a template, and revision information including revision number, date and description of revisions made. This information may be organized into one or more directories within the database 14.

A user who is unfamiliar with the various templates and the various gas turbine parts that are separated by the templates, may search the database 14 to identify a template(s) that best suits the user's requirements. User information profiles may also be stored in the database 12.

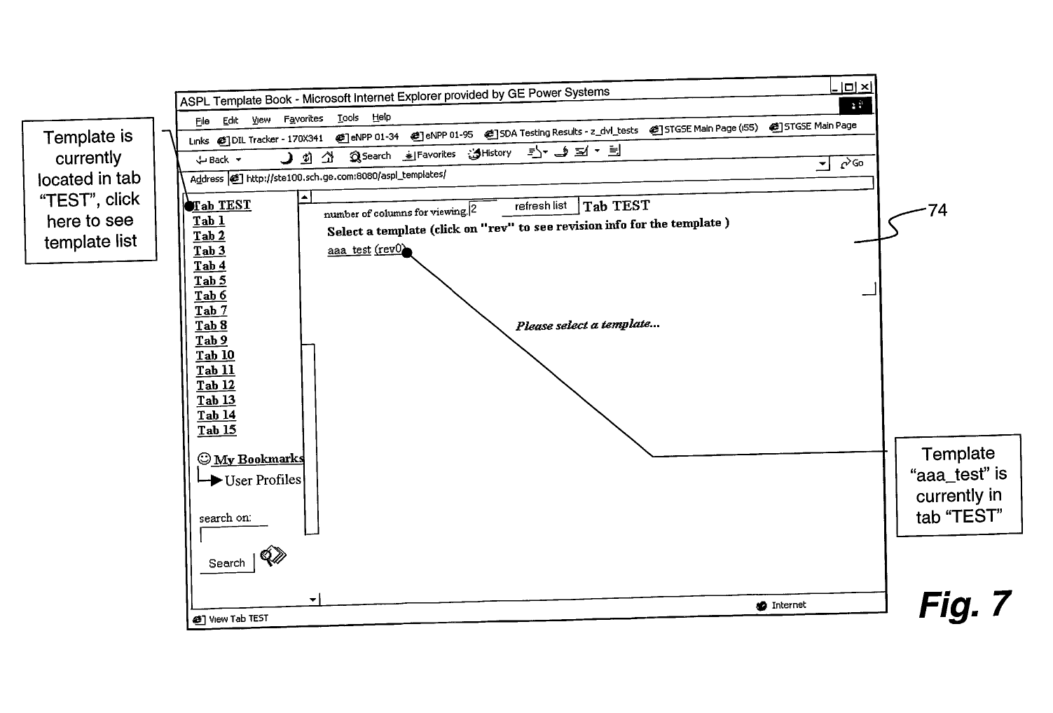

User profiles include such exemplary information as a user's e-mail address, Tab preferences and any changes to the preferences that require notification to a respective user, the number of columns of a template that are viewed by a user when a template is listed, printer to which a user last printed to, and any templates that a user prefers to bookmark within the database system 14 (FIG. 2). Such a user profile may be organized under the user's bookmarks identified at “my bookmarks” in the screen shot shown in FIG. 7.

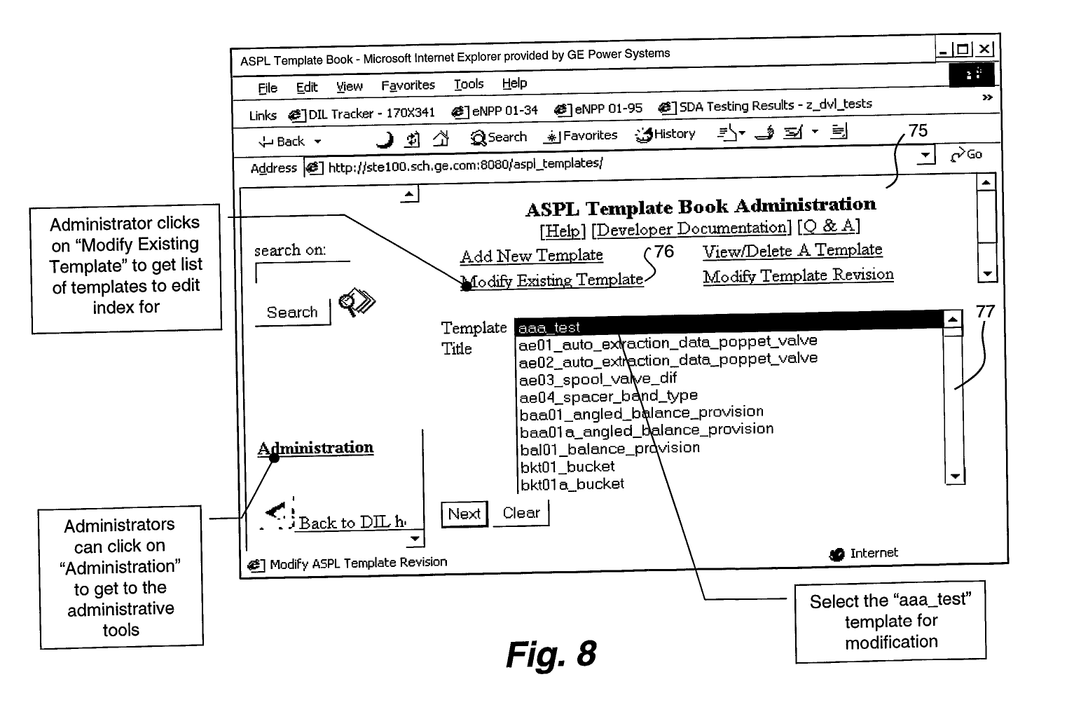

FIGS. 7 through 10 show various user interface screen shots illustrating the steps involved in the reorganization of templates to various sections or tabs without reprogramming or physically moving the underlying files making a template. Reorganization of templates can be effected through administrator station 30. FIG. 7 particularly shows a screen shot for enabling an administrator or an authorized user for performing various actions related to a template. Such actions include, for example, adding a new template, modifying an existing template, modifying a template revision, etc.

For example, the user interface screen shot 74 as in FIG. 7 shows a template identified as “aaa_test” as currently being located under a Tab identified as “TEST”. In order to reorganize the template “aaa_test” into another tab/section, for example, within Tab 1 through Tab 15 or to a newly created Tab, an administrator selects “modify existing template” link identified by reference numeral 76 of user interface screen 75 shown in FIG. 7. Once the “modify existing link” is selected by the administrator, a list of templates (generally indicated in field 77) are displayed to the administrator. The administrator may select any one of the displayed templates in the field 77 in order to reorganize the selected template into a different or a newly created tab/section.

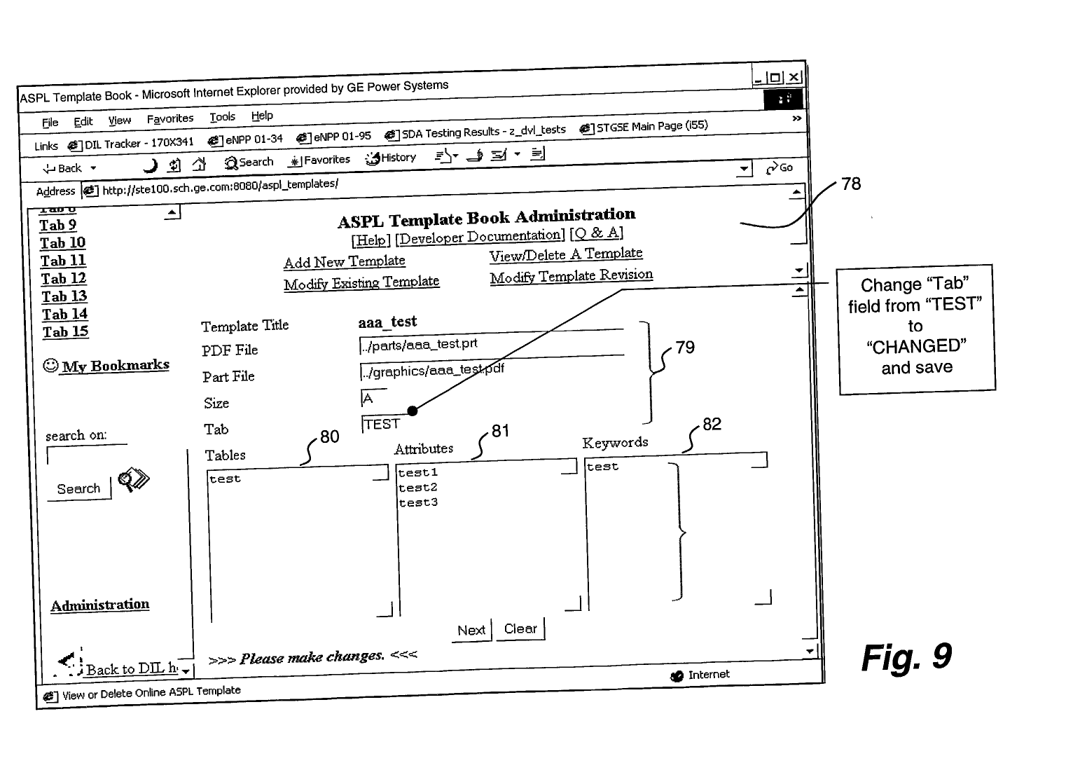

Once a template from the field 77 is selected for reorganization by the administrator, the screen of FIG. 9 appears illustrating to the administrator details about the selected template as indicated on user interface 78 (FIG. 9). Exemplary details of a selected template, which include associated PDF file information, location of a part file, size of the files, and the tab/section where the selected file is currently organized, are displayed in fields collectively indicated by reference numeral 79. Fields 80-82, respectively, disclose tables, attributes, and keywords associated with a selected file.

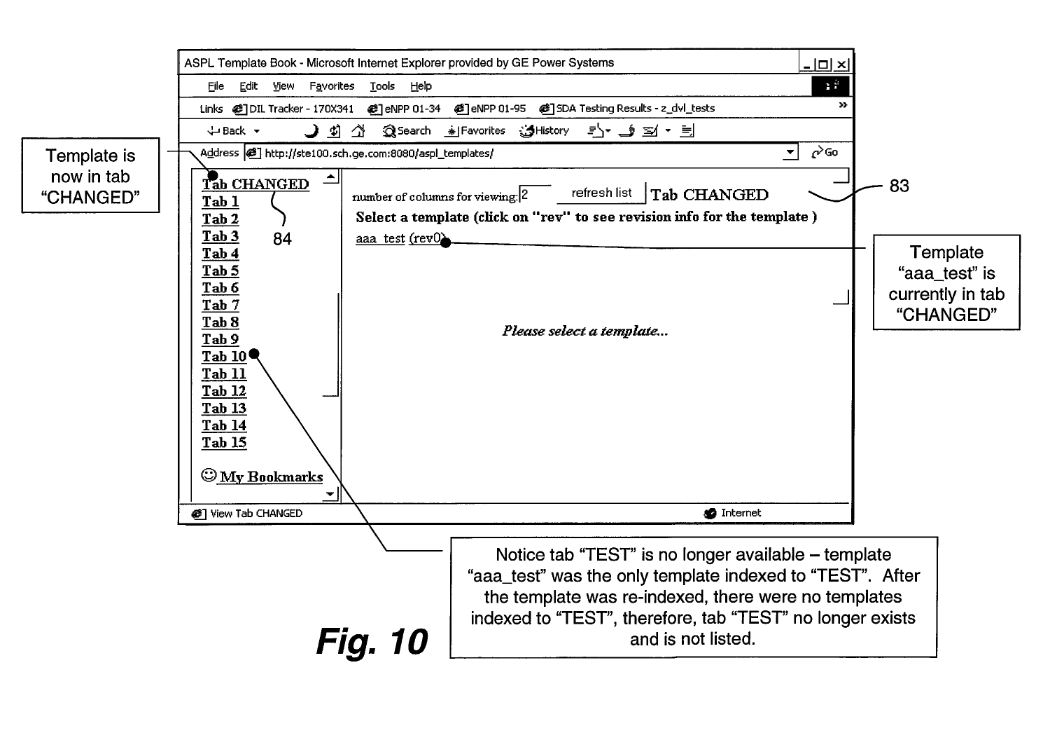

The administrator upon changing the “Tab” field from “TEST” to a new field, for example, “CHANGE”, creates a user interface 83 as shown in FIG. 10. A new tab/section listed as “Tab CHANGED” and identified at 84 is created by the administrator. Thus, the template “aaa_test” and underlying template files are now automatically reorganized to tab “CHANGED” and any references to old tab “TEST” are automatically deleted. Revision changes made to a template may be stored in the template's index file(s) in the database 14.

An automated process may be used to search through the index files to look for changes made to various templates. The automated process may be initiated by the user to run on web server 12 in the background, and notifications may be sent to registered users for changes made to the tabs/sections specified by the users. The templates may be printed using a Unigraphics (UG) background process that may be initiated by a web frontend of server 12 (FIG. 2). Although the template “aaa_test” is relocated to another tab/section, in actuality, neither files were moved nor was programming done to cause this relocation. A script may be created for performing a batch change by a file owner.

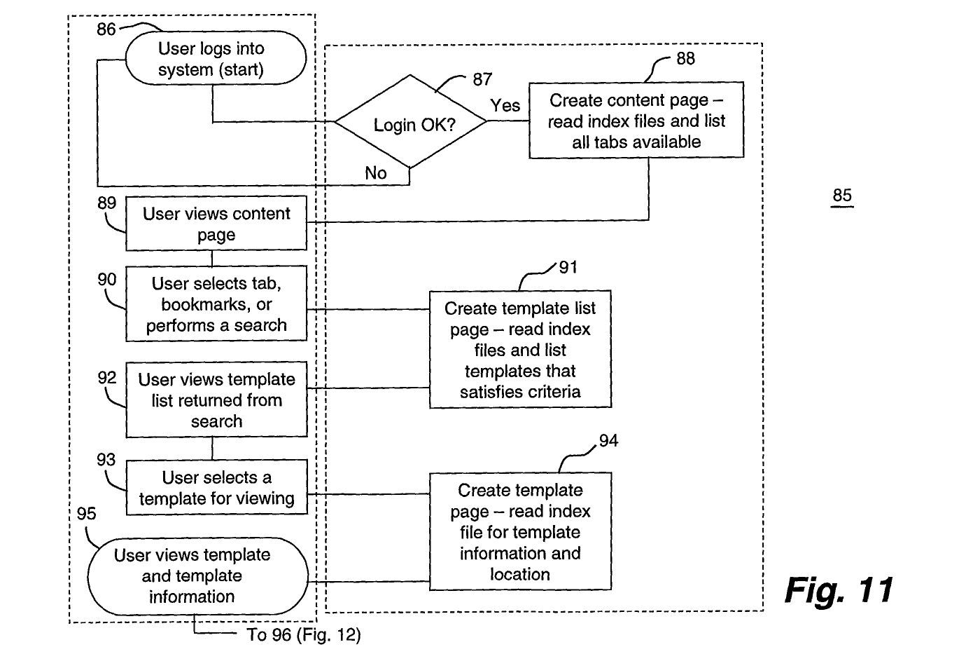

FIG. 11 shows a flowchart for obtaining access to the template files and using the same in accordance with an exemplary embodiment of the present invention. A user logs into the web server 12, using an assigned username and a password as indicated at step 86. If the user login is successful, a content page is fetched from the storage device 13 of server 12 (FIG. 2), the content page including a plurality of Tabs (see, e.g., list 54 in FIG. 3) are displayed to the user. The content page is preferably transmitted to a requesting user via a packet switching network, such as, for example, Internet 18. This procedure is generally indicated at step 88.

The list of Tabs is derived from a plurality of index files, each index file representing a template. Upon viewing the content page (step 89), as illustrated by step 90, the user has options of (a) selecting a Tab and a file from among a plurality of files listed in the selected Tab if the user is knowledgeable about a specific file, (b) selecting a file from the user's prior set bookmarks, or (c) performing a search if the user is not sure about a specific template that suits the user's needs. Upon locating required templates, the user creates a list of the required templates, identifies the location where each template is stored, and retrieves the located template(s) the content of which is displayed on a display device at a user station, such as for example 28 (FIG. 2). This process is generally depicted at steps 91 through 95.

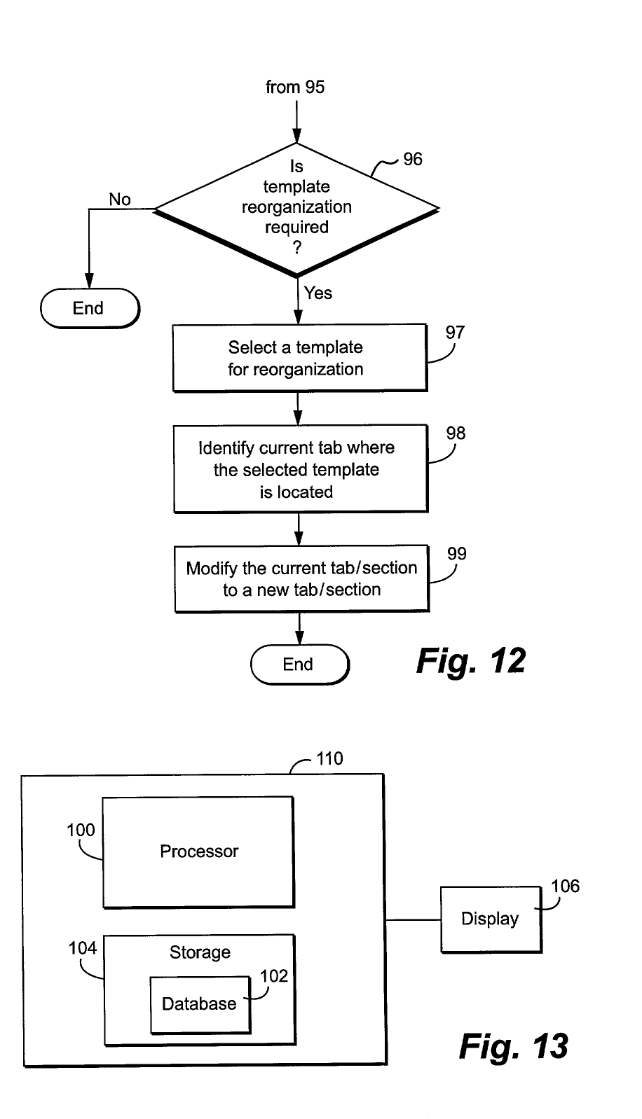

FIG. 12 shows a flowchart for reorganizing a template from one tab/section to a new tab/section without actually moving the files underlying the template or performing programming to reorganize files making the template. Once a determination is made to reorganize a template, the current tab/section where the selected template is located is identified and changed to represent a new tab/section where the template is intended to be located. This procedure is generally indicated at steps 96 through 99. Various user interface screen shots identifying each of the steps 96 through 99 are shown in FIGS. 7 through 10 and described as above with respect to those Figures.

FIG. 13 illustrates the details of a computer system 110 used by a user at a user station 28 or an administrator at administrator station 30. The computer system 110 is shown to include a processor 100, a database 102, and a storage device 104. The storage device 104 preferably stores the database 102. Alternatively, the database 102 may be located outside of the storage device 104. Information processed in the computer system 110 is displayed on a display device 106.

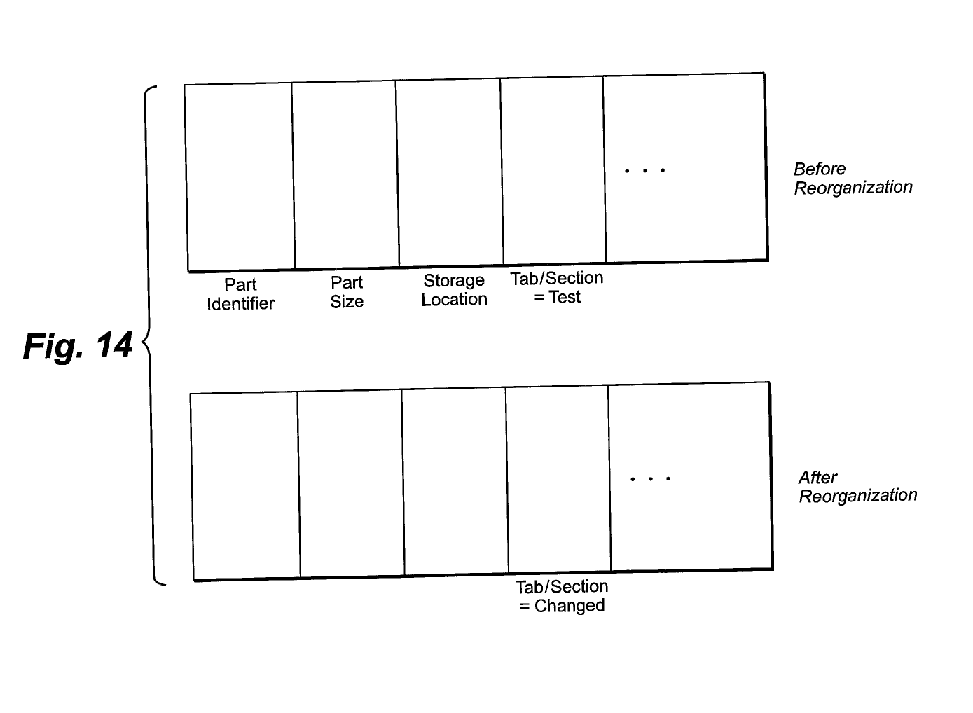

FIG. 14 shows an exemplary file structure of an index file before and after reorganization of a template from one tab/section to another as illustrated in FIGS. 7-10.

The templates organized by the present invention are systematically organized in a single directory, easy to read, and enable a user to view the templates across various platforms. The templates are preferably formatted in an Acrobat PDF format to enable users to easily read the templates without platform restrictions. The PDF format enables the users to either zoom-in or zoom-out of respective drawings to legibly display information associated with a specific template. Selected templates may be printed on pre-designated printers using application software, such as, for example, Unigraphics.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. For use in designing a gas turbine engine, a database having a plurality of sections, each section storing one or more templates, a method of reorganizing a select template from one section to a different section within said plurality of sections, the method comprising the steps of:
reviewing an index file corresponding to the select template to identify a section among said plurality of sections where the select template is organized; and
editing a storage location of the index file to identify a different section among said plurality of sections to reorganize the select template to the different section without moving underlying files of the select template between the plurality of sections to design the gas turbine engine.

2. The method as in claim 1, wherein said templates are in PDF format.

3. The method as in claim 1, further comprising:
including a storage location of the select template in a header portion of a corresponding index file.

4. The method as in claim 1, further comprising:
populating each index file with corresponding template details.

5. The method as in claim 1, further comprising:
enabling a user to search contents of said one or more templates.

6. The method as in claim 1, further comprising:
tracking templates having altered index files; and
notifying users of template reorganization.

7. The method as in claim 1, further comprising:
providing in each index file one or more of (i) fields identified within a template, (ii) storage locations of components described by a template, (iii) revision and update information of a template.

8. The method as in claim 7, further comprising:
including in the revision information at least one of a revision number, revision date, or description of revisions performed.

9. The method as in claim 5, further comprising:
storing user profiles as text files in a server.

10. A computer program product having a computer useable medium having computer program logic stored thereon for enabling a processor in a computer system to process data, said computer program product comprising:
a database having a plurality of templates stored therein for use in turbine design;
means for checking an index file corresponding to a select template to identify a section among a plurality of sections where the select template is organized;
means for editing a storage location of the index file to reorganize the select template to a different section among said plurality of sections without moving underlying files of the select template between the plurality of sections.

11. The computer program product as in claim 10, further comprising:
means for tracking templates having altered index files; and
means for notifying users of template reorganization.

12. The computer program product as in claim 10, wherein said templates are in PDF format.

13. The computer program product as in claim 10, wherein location of the select template is organized in a header portion of a corresponding index file.

14. The computer program product as in claim 10, wherein each index file includes information of a corresponding template.

15. The computer program product as in claim 10, further comprising:
means for enabling a user to search contents of each of the plurality of templates.

16. A computer-based method for reorganizing a template among a plurality of templates stored in a plurality of sections within a database for use in turbine design, the method comprising:
storing the plurality of templates in a first organized model in said database, each template having an associated index file;
displaying said plurality of templates and an index file corresponding to a selected template by user action; and
editing the index file to reorganize the selected template from the first organized model to a second organized model.

17. In a electronic communication network having a client computer system communicatively coupled to a server computer for accessing information stored therein for use in designing a gas turbine engine, the server computer comprising:
a memory for storing a plurality of templates in a first organized model in said memory, each template having an associated index file;
a software application stored in said memory for retrieving and displaying template information on a display device of said client computer system in response to user action; and
said software application enabling a user to edit an index file corresponding to a displayed template to reorganize the displayed template from the first organized model to a second organized model.

18. A method of reorganizing a plurality of templates for designing a gas turbine engine, the templates being organized in a plurality of sections within a database, the method comprising:
displaying the plurality of templates, each template having an associated index file indicating a section where a respective template is stored;
enabling a user to select a template from the plurality of templates;
displaying contents of the select template to the user;
enabling the user to modify the index file associated with the select template for reorganizing the select template to a different section among said plurality of sections; and
the reorganization step being executed without moving files making up the select template.

19. A method for reorganizing one or more templates arranged in a plurality of sections in a database of a remote server, the server using a software application, the method comprising:
communicatively coupling the server to a plurality of remote client computers;
accessing the server from one or more said client computers;
analyzing the software application to identify one or more of functions, processes, procedures, and steps for reorganizing said one or more templates;
identifying an index file corresponding to respective said one or more templates;
editing a select index file to reorganize a template corresponding to the select index file; and
displaying reorganized templates to a user for enabling a user to design a turbine.

20. A method for reorganizing files stored in a file management system, the files arranged in a plurality of sections within the file management system, the method comprising:
accessing a server from one or more remote client computers, the server storing the file management system;
retrieving and displaying the plurality of sections on a remote client computer;
selecting a section from the plurality of sections;
displaying templates included in the selected section;
selecting a template from the displayed templates;
displaying an image corresponding to the selected template;
editing an index file corresponding to the selected template for reorganizing the selected template into another section among the plurality of sections without moving underlying template files between the plurality of sections.

21. A system having a storage device, comprising:
information having segments;
the storage device having
a set of templates, each template indicating the content of a corresponding one of said segments, the templates being arranged in an organized first model reflecting relationships among corresponding segments; and
software for reorganizing said templates into a second model and displaying the reorganized templates, the software further enabling a user to access contents of the second model by invoking a corresponding template in the second model.
